(19) United States
(12) Patent Application Publication
(10) Pub. No.: US 2011/0159474 A1
(43) Pub. Date: Jun. 30, 2011

(54) SOLUTIONS FOR PERFUSING AND PRESERVING ORGANS AND TISSUES

(75) Inventors: Johannes-Peter Stasch, Solingen (DE); Reiner Frey, Woppertal (DE)

(73) Assignee: Bayer Schering Pharma Aktiengesellschaft, Berlin (DE)

(21) Appl. No.: 12/663,235

(22) PCT Filed: May 24, 2008
(86) PCT No.: PCT/EP2008/004158

§ 371 Date: Dec. 30, 2010

(30) Foreign Application Priority Data
Jun. 6, 2007 (DE) 10 2007 026 392.0

(51) Int. Cl. A01N 1/02

(52) U.S. Cl. 435/1.2

(57) ABSTRACT

The present invention relates to solutions which are suitable for the perfusion and preservation of organs, organ parts, tissues or tissue parts of human or animal origin. The solutions suitable for this contain at least one active agent, which is selected from the group of NO-independent stimulators and activators of soluble guanylate cyclase. The invention furthermore relates to methods for producing the solutions according to the invention, and to the use of the solutions in various types of medical procedures, particularly in the field of transplantation medicine.

The present invention relates to solutions which are suitable for the perfusion and preservation of organs, organ parts, tissues or tissue parts of human or animal origin. The invention furthermore relates to methods for producing the solutions according to the invention, and to the use of the solutions in various types of medical procedures, particularly in the field of transplantation medicine.

Although organ transplantations have now become a standard part of medical care, the success of such operations is still unsatisfactory. Since the donor organ is not supplied with blood in the time between removal and implantation in the recipient, cell damage and necrotic tissue modifications can occur owing to lack of oxygen during this ischemia time, so that the vitality and functionality of the organ in question are impaired. Ischemia-induced damage to the vascular endothelials is of particular importance in this case.

Furthermore, the formation of free radicals and cellular mediators due to oxidative stress in reperfusion of the implanted organ can cause an ischemia-reperfusion syndrome which leads to failure of the transplant (=primary transplant failure or “initial nonfunction”). Function recovery of the reperfused organ is then entirely absent or greatly restricted. This is essentially attributable to the disruption or obstruction of microcirculation due to ischemia and reperfusion.

Ischemia- and/or reperfusion-induced damage to the tissue, in particular the endothelium, can also cause long-term complications, for example secondary transplant failure due to thrombotic vascular modifications. In the case of vascular transplants, the susceptibility to restenosis can be enhanced.

The complications described above can occur not only in organ transplantations but also in other surgical interventions on ischemic organs, for example in cardiosurgical operations with the use of a heart-lung machine.

In order to reduce as far as possible the occurrence of ischemic damage in organs, particularly transplants, the ischemia time should in principle be as short as possible. On the other hand, extending the ischemia time is desirable so that sufficient time is left for transporting the transplant from the donor to the recipient and for optimal selection of donors and recipients according to a tissue match. Extending the ischemia time is also desirable in order to allow more complicated operations with an extended operation time.

Conventionally, buffered physiological electrolyte solutions which are provided with various types of additives are used as protective, preservation and perfusion solutions in order to protect organs against ischemic damage. Examples of standard solutions which are usual in the prior art are:
Bretschneider solution (EP 12272 A1, EP 1362511 A1);
Bretschneider's HTK solution (EP 54635 A1; with histidine, tryptophan and α-ketoglutarate), commercial product: Custodiol®;
Euro-Collins solution (a hyperosmolar solution, the ion composition of which corresponds to that of the intracellular space);
UW solution (University of Wisconsin solution);
St. Thomas' Hospital solution (Plegisol®);
Viaspan® (“Belzer UW”; U.S. Pat. No. 4,798,824 B1, U.S. Pat. No. 4,879,283 B1; DuPont-Pharma GmbH, Bad Homburg);
Celsior® (Imtix Sangstat, Lyon);
Perfadex® (Vitrolife A B, Gothenburg);
Polysol® (WO 2006/052133 A2).

When using standard solutions of the type described above, the occurrence of ischemic damage or ischemia-reperfusion damage is always to be expected.

In order to keep the extent of ischemic damage as small as possible, the perfusion solutions are usually employed under hypothermic conditions (at about 4 to 10° C.), i.e. with “cold ischemia”. The occurrence of ischemia-reperfusion damage cannot be prevented by this.

Various additives for organ perfusion solutions, which are intended to cause a reduction of ischemic damage or ischemia-reperfusion damage, have been proposed in the literature, for example benzopyrone (DE 198 44 116 A1), glutathion (DE 41 38 040 A1), insulin (EP 1 164 841 B1) or superoxide dismutase (WO 02/30192 A2). However, the action of such additives is insufficient and their use entails disadvantages, for example the occurrence of side-effects, stability problems, or increased costs.

It was therefore an object of the invention to provide perfusion and preservation solutions for organs and tissue, with which the above-described disadvantages of the known solutions are avoided or reduced. In particular, it was an object to provide perfusion and preservation solutions which allow an extended ischemia time, a reduction of ischemia-induced damage and/or improved function recovery of a transplanted organ, and by which ischemia-reperfusion damage can be avoided or reduced.

This object is surprisingly achieved by providing a perfusion and preservation solution which, according to the present invention, contains at least one active agent which is selected from the group that comprises NO-independent stimulators and activators of soluble guanylate cyclase. The object is furthermore achieved by the uses and methods defined in the patent claims.

It has been found that the occurrence of cell, tissue and organ damage under ischemic conditions is reduced significantly by using the perfusion and preservation solutions according to the invention. It has furthermore been found that organs or tissue showed improved function recovery in subsequent (re-)implantation after treatment with a solution according to the invention, compared with standard solutions which do not contain said active agents. It has been possible to reduce significantly the frequency of the occurrence of primary or secondary transplant failure by using the solutions according to the invention.

The solutions according to the invention are suitable in particular for the perfusion and preservation (i.e. storage) of organs, in particular hollow organs, and organ parts, tissues or tissue parts, respectively of human or animal origin.

NO-independent stimulators and activators of soluble guanylate cyclase (sGC) are known to the person skilled in the art (EVGENOV O. E. et al., Nature Reviews Drug Discovery Vol. 5, September 2006, 755-768). In general, these are compounds that bring about NO-independent (i.e. direct) activation or stimulation of sGC, or an increase in the sGC activation caused by NO, which results in an increase of the intracellular cGMP concentration.

Activators of sGC refers to compounds which bring about a haem-independent activation of sGC. This active agent group of NO-independent and haem-independent activators of sGC (=sGC activators) is particularly advantageous since these activators even have an activating effect on haem-deficient or oxidized forms of sGC, i.e. in the event of oxidative stress.

Stimulators of sGC (=sGC stimulators) refers to compounds which bring about an NO-independent but haem-dependent activation of sGC.

Stimulators in the scope of the present invention generally include all compounds which cause NO-independent stimulation or activation, or an increase or exponentiation of sGC activity, and/or which additively or synergistically enhance activation of sGC due to NO or CO.

The solutions according to the invention may contain as active agent(s) a single compound or combinations of two or more compounds from the group of NO-independent stimulators and activators of sGC.

Use of the term “solution” does not preclude the solutions according to the invention from containing proportions of dissolved substances, for example in suspended, colloidal or emulsified form.

According to a preferred embodiment, a solution according to the invention contains at least one NO-independent activator of soluble guanylate cyclase which is selected from the group of dicarboxylic amino acid derivatives. Such active agents and their preparation and therapeutic use have been disclosed in WO 01/19780 A2 and WO 2007/025595 A1. All the active agents disclosed therein may be envisaged for the purposes of the present invention, particularly the compounds described in WO 01/19780 A2 (pp. 97-171; synthesis examples 1-232).

A compound of the following Formula (I) is particularly preferably used as an active agent. This substance has likewise been described in WO 01/19780 A2 (cf. p. 103, Ex. 8).

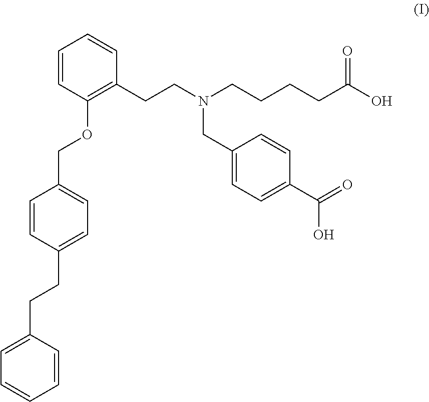

Further dicarboxylic amino acid derivatives and dicarboxylic acid derivatives, which may be used according to the present invention, have been disclosed in WO 01/19355 A1, WO 01/19776 A1, WO 01/19778 A1, WO 02/070462 A1, WO 2002/070459 A1, WO 02/070510 A1, WO/2007/045433 A1.

According to another preferred embodiment, a solution according to the invention contains at least one activator of soluble guanylate cyclase which is selected from the group of sulfur-substituted sulfonylamino carboxylic acid N-arylamides. Such active agents and their preparation and medicinal use have been disclosed in WO 00/02851 A1. All the active agents disclosed therein may be envisaged for the purposes of the present invention, particularly the compounds described in examples 1-226 (pp. 39-65), the compounds (II), (III) and (IV) given below being particularly preferred:

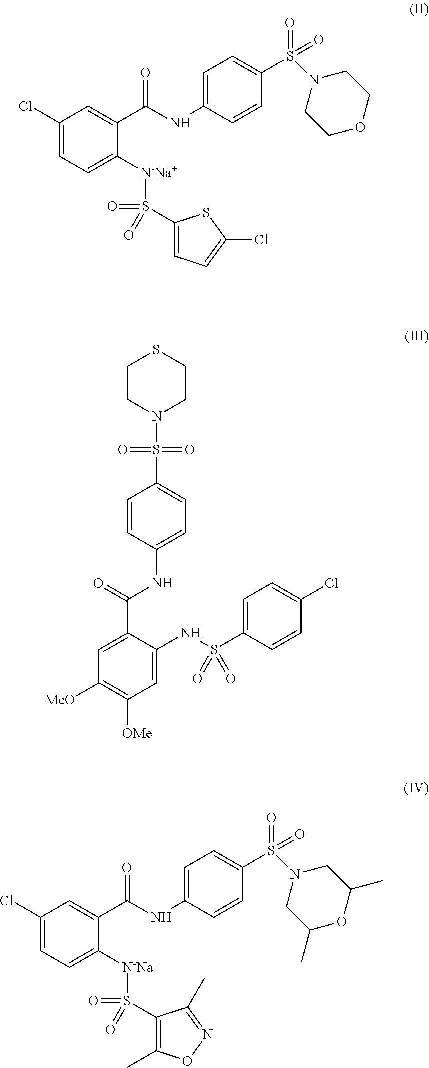

According to another preferred embodiment, a solution according to the invention contains at least one haem-dependent stimulator of soluble guanylate cyclase which is selected from the group of substituted pyrazole derivatives, in particular from the group of pyrazolopyridine derivatives. Suitable pyrazole derivatives and methods for their preparation have been described for example in WO 98/16507 A1, WO 98/23619 A1, WO 98/16223 A1, WO 00/06567 A1, WO 00/06568 A1, WO 00/06569 A1, WO 00/21954 A1, WO 01/083490 A1, WO 02/042299 A1, WO 02/042300 A1, WO 02/42301 A1, WO 02/42302 A1, WO 02/092596 A1, WO 03/004503 A1, WO 03/095451 A1, WO 03/097063 A1, WO 03/095452 A1.

Among the group of substituted pyrazole derivatives, the compounds of the following Formulae (V) to (VIII) are particularly preferred:

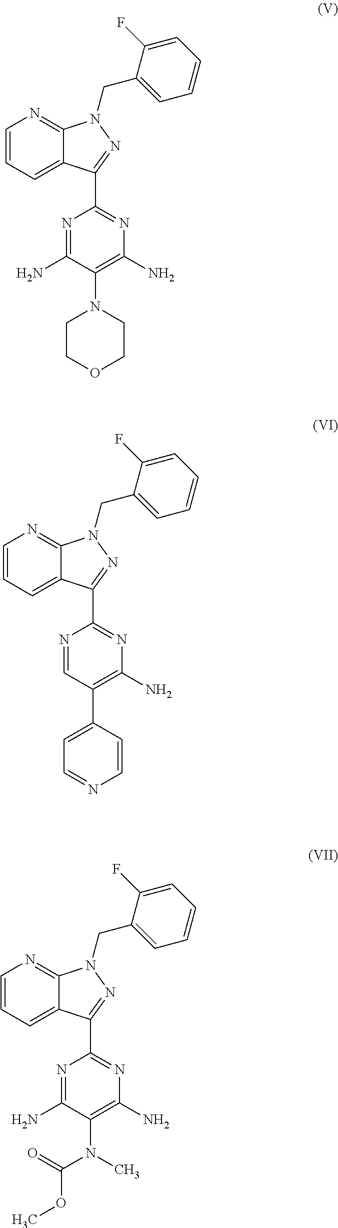

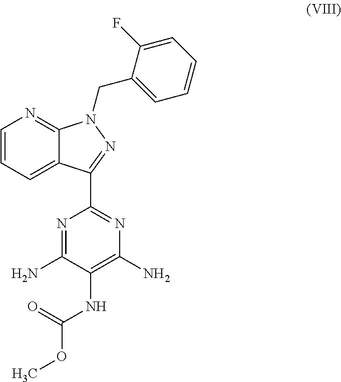

The preparation of these compounds has been described in WO 00/06569 A1 (V), WO 00/06569 A1 and WO 02/42301 A1 (VI), or in WO 00/06569 A1 and WO 02/095451 A1 (VII, VIII).

The pyrazole derivatives and indazole derivatives disclosed in WO 00/27394 A1 may also be envisaged as stimulators or activators of sGC, the sGC stimulator 3-[3-(di-methylamino)propoxy]-N-(4-methoxyphenyl)-1-(phenylmethyl)-1H-pyrazole-5-carboxamide hydrochloride being particularly preferred.

According to another preferred embodiment, a solution according to the invention contains at least one haem-dependent stimulator of soluble guanylate cyclase which is selected from the group of indazole derivatives, in particular benzylindazole derivatives, 3-(5′-hydroxymethyl-2′-furyl)-1-benzylindazole being preferred (Ko F N et al., Blood 84 No. 12, 1994, 4226-4233). Further suitable indazole derivatives are disclosed in WO 03/076408 A2.

According to another preferred embodiment, a solution according to the invention contains at least one haem-dependent stimulator of soluble guanylate cyclase which is selected from the group of acrylamide derivatives, 3-[2-(4-chlorophenylthio)phenyl]-N-(4-dimethylaminobutyl)acrylamide being particularly preferred (see Miller L N et al., Life Sci., 72 (2003), 1015-1025; Nakane M et al., J. Pharmacol. Sci., Vol. 102, 231-238 (2006)).

Further compounds, which may be used as stimulators according to the present invention, are described in the following documents: WO 2004/009590 A1 (pyrimidine derivatives), WO 2004/009589 A1 (2,5-disubstituted pyrimidine derivatives), WO 2004/031186 A1 (morpholine-bridged indazole derivatives), WO 2007/045366 A1 (heterocyclic compounds having carboxyl-isostere groups), WO 2007/045367 A1 (cyclopropylacetic acid derivatives), WO 2007/045369 A1 (difluorophenol derivatives).

The content of the documents referred to in the preceding sections, in particular the compounds mentioned in general and above all specifically therein, are expressly a part of the description of the present invention.

The above-described stimulators and activators of sGC, which according to the present invention may be used as active agents in solutions for the perfusion and preservation of organs, tissues and cells, may respectively be used in the form of their free bases or free acids, or in the form of their salts, hydrates, or hydrates of salts. Suitable pharmaceutically acceptable salts are known to the person skilled in the art. The following may for example be envisaged as salts: hydrochloride, hydrobromide, sodium salts, fumarate, citrate, acetate, propionate, oxalate, succinate, lactate, butyrate, methanesulfonate, sulfate, aspartate, decanoate, maleate, tartrate, hydrogen tartrate, phosphate.

The solutions according to the invention are preferably formulated as physiological electrolyte solutions which contain said active agent(s). The total active agent concentration in the solution is preferably in the range of from 0.1 nmol/l to 100 μmol/l, in particular from 0.5 nmol/l to 5 μmol/l. The optimal active agent concentration may respectively be determined in a manner known to the person skilled in the art. Suitable physiological electrolyte solutions, which may be used for producing a solution according to the invention, are known to the person skilled in the art.

According to a preferred embodiment, solutions according to the invention are produced as base solutions which are modified by adding said active agent(s). A conventional or commercially available organ preservation or organ perfusion solution is preferably used as a base solution.

In particular, the known solutions already mentioned above may be envisaged as base solutions, i.e. UW solution (=University of Wisconsin solution), St. Thomas' Hospital solution; Bretschneider's HTK solution, Euro-Collins solution, Viaspan® (“Belzer UW”), Celsior®, Perfadex®, Polysol®. Known clinically conventional infusion solutions may also be used as base solutions for producing solutions according to the invention. Blood plasma, blood serum or blood substitute may also be used as a base solution.

In general, a physiological solution suitable as a base solution contains electrolytes (sodium, potassium, magnesium, calcium, chloride) in a composition which corresponds to the extracellular or intracellular milieu, as well as a buffer system (for example phosphate buffer, carbonate buffer, HEPES, MOPS; at pH 7.2-7.6), colloid osmotic substances (for example dextran, hydroxyethyl starch) and glucose or other sugars, and further optional constituents such as mannitol, glutathione, ATP, gluconate, lactobionate. The osmolarity is generally adjusted so that it corresponds to that of plasma or the intracellular milieu.

Examples of base solutions which are suitable for producing solutions according to the invention have been described in EP 12272 A1, EP 1362511 A1, EP 54635 A1, U.S. Pat. No. 4 798 824 B1, U.S. Pat. No. 4,879,283 B1 and WO 2006/052133 A2.

According to another preferred embodiment, the present invention relates to cardioplegic solutions which respectively contain at least one active agent selected from the group comprising NO-independent stimulators and activators of soluble guanylate cyclase. For example, the following may be envisaged as cardioplegic solutions: Bretschneider's HTK solution; St. Thomas' Hospital cardioplegic solution. For example, the following may be used as cardioplegic agents: potassium ions (>15 mM), lidocaine, novocaine, procaine.

According to another preferred embodiment, the present invention also comprises solutions which additionally contain one or more further pharmaceutical active agents, which are not selected from the group of stimulators and activators of sGC. These further pharmaceutical active agents may in particular be selected from the group which comprises vasodilators, thrombocyte aggregation inhibitors, thrombolytics, coagulation inhibitors, phosphodiesterase inhibitors, adenosine agonists, prostaglandins, glucocorticoids, anti-inflammatory active agents and antibiotics.

The solutions according to the invention are generally produced as solutions ready for use. As an alternative, the solutions may also be in the form of concentrates which need to be diluted appropriately before use in order to adjust the required final concentration. Furthermore, the present invention also comprises kits which contain a defined volume of a base solution together with a defined amount of a stimulator and/or activator of sGC, as described above.

The invention furthermore relates to a method for producing perfusion or preservation solutions for organs, organ parts, tissues or tissue parts of human or animal origin. The method is based on at least one active agent, which is selected from the group that comprises NO-independent stimulators and activators of soluble guanylate cyclase, being added to a physiological electrolyte solution, for example a preservation or perfusion solution of known composition, as described above.

The invention furthermore relates to the use of one of the solutions described above as a protective solution, preservation solution, storage solution or as a preparation medium for organs, organ parts, tissue, tissue parts and/or cells. Said organs, organ parts etc. may be of human or animal origin. The solutions according to the invention may be used in particular before, during and after explantation (i.e. organ or tissue removal), or during an ex-vivo treatment of isolated organs, organ parts, tissues, tissue parts and/or cells.

The organ-, tissue- and cell-protecting effect of the solutions according to the invention is achieved both under warm ischemia (i.e. at body temperature, or in the absence of cooling measures) and under cold ischemia. The solutions are preferably used when cooled, in particular at from 1 to 12° C., particularly preferably at from 4 to 8° C. When using the preservation solutions according to the invention, the preservation time (i.e. the “cold ischemia time”) for isolated ischemic organs, for example a heart or kidney, can be extended to add to 96 h, preferably 72 h, with storage under hypothermic conditions (about 1 to 12° C.), while sustaining the vitality and functionality of the organ preserved in this way.

The invention furthermore relates to the use of a solution as claimed in one of the preceding claims as a perfusion solution or reperfusion solution for organs, organ parts, tissue or tissue parts of human or animal origin. A perfusion solution according to the invention may in particular be employed before during or after explantation, or during the ex-vivo storage of an explanted organ, organ part, tissue or tissue part.

A solution according to the invention is preferably employed as a reperfusion solution before, during or after implantation of an explanted organ, organ part, tissue or tissue part, i.e. for the reperfusion of an organ, organ etc. after a preceding ischemia time and before restoring the blood supply after transplantation or re-implantation has been carried out.

The invention furthermore comprises the use of a solution according to the invention, as described above, as a protective solution or perfusion solution in surgical interventions on body organs, particularly in cardiosurgical interventions. The solutions according to the invention may preferably be used as machine perfusion solutions, for example in heart-lung machines.

According to another embodiment, the invention relates to the use of an active agent which is selected from the group comprising NO-independent stimulators and activators of soluble guanylate cyclase, or a combination of at least two such active agents, for producing a perfusion and preservation solution for organs, organ parts, tissue or tissue parts of human or animal origin, for the following therapeutic or prophylactic purposes:
to prevent or reduce ischemic damage in transplants, or
to prevent or reduce reperfusion damage, in particular to prevent an ischemia-reperfusion syndrome; or
to protect against organ or tissue damage during the explantation, storage or transport of explanted organs or tissues; or
for the preservative treatment of explanted organs or tissues, or
to improve function recovery in the re-implantation of organs or tissues, or
to prevent or reduce restenosis in vascular transplantations; or
to prevent transplant failure or
to extend the ischemia time in surgical interventions, particularly in cardiosurgical interventions;
to prevent or reduce postoperative complications, in particular after interventions under ischemic conditions.

The organs mentioned in connection with the present invention are in particular the heart, the lung, the liver, the kidney, the pancreas, the spleen, the intestines or the bladder. In particular, the following may be envisaged as organ parts: heart valves, blood vessel sections, liver lobes, intestine sections, muscle preparations, limbs. Skin transplants in particular are envisaged as tissue or tissue parts. As cells, the islet cells of the pancreas may in particular be envisaged.

The terms “transplant” or “transplantation” refer in particular to autologous, syngeneic, allogeneic or xenogeneic transplants or transplantations.

According to another embodiment, the present invention relates to a method for treating isolated or explanted human or animal organs, organ parts, tissues or tissue parts in order to sustain viability or to protect against organ or tissue damage. The method according to the invention comprises at least one method step in which the isolated or explanted organ, organ part, tissue or tissue part is brought in contact with at least one active agent which is selected from the group comprising NO-independent stimulators and activators of soluble guanylate cyclase. One of the solutions according to the invention as described above is preferably used for this. The contact may in particular be carried out by the isolated or explanted organ, organ part, tissue or tissue part being brought in contact with a liquid containing said active agent, immersed, incubated or stored therein, or perfused with this liquid.

The present invention furthermore relates to a method for the transplantation, in particular for the allogeneic or syngeneic transplantation of a human or animal organ, organ part, tissue or tissue part. The method according to the invention comprises at least one of the following steps:

(i) bringing an explanted organ, organ part, tissue or tissue part in contact with at least one active agent, which is selected from the group comprising NO-independent stimulators and activators of soluble guanylate cyclase;
(ii) implanting the organ, organ path, tissue or tissue part in a recipient body and bringing the organ, organ part, tissue or tissue part in contact with said active agent before, during or after implantation.

One of the solutions according to the invention as described above is preferably used for this. The contact is preferably carried out by means of one or more of the following methods: perfusion, immersion, rinsing, injection.

By the above-described treatment of the organ, organ part, tissue or tissue part with said active agent, ischemic damage to the organs and tissue is suppressed or prevented and a prophylactic effect is achieved in respect of ischemia-reperfusion damage.

According to a variant of the method described above, the organ or tissue is already brought in contact with at least one of said active agents or with said solution before removal from the donor body, for example a human organ donor. Early-commencing protection of the donor organ against tissue and cell damage is thereby achieved.

The invention furthermore relates to a method for preserving or storing isolated or explanted organs, organ parts, tissues, tissue parts or cells of human or animal origin. The method comprises a method step in which the organs, organ parts, tissue, tissue parts or cells are immersed in a liquid which contains at least one active agent selected from the group comprising NO-independent stimulators and activators of soluble guanylate cyclase and stored therein. A solution of the type described above is preferably used as the liquid.

According to another embodiment, the invention relates to methods for surgically treating an organ or tissue, in particular under ischemia. According to the invention, these methods comprise a method step in which the organ or tissue is brought in contact with at least one active agent which is selected from the group comprising NO-independent stimulators and activators of soluble guanylate cyclase. This is preferably done by means of perfusion with one of the solutions described above. The method may be employed particularly in cardiosurgical interventions, for example in bypass operations or heart valve operations.

### EXAMPLES

The invention and its advantageous effects will be explained in more detail by the following examples:

### 1. Cardioplegic Preservation and Perfusion Solution

In order to produce the solution, a Bretschneider's HTK solution was used as a base solution. Compound (I) was added to this solution with a final concentration of 10 nmol/l.

The composition of the solution is as follows:

| | | |
|---|---|---|
| sodium chloride | 15.0 | mmol/l |
| potassium chloride | 9.0 | mmol/l |
| magnesium chloride (6 H₂O) | 4.0 | mmol/l |
| histidine-HCl (H₂O) | 18.0 | mmol/l |
| histidine | 180.0 | mmol/l |
| tryptophan | 2.0 | mmol/l |
| mannitol | 30.0 | mmol/l |
| calcium chloride (2 H₂O) | 0.015 | mmol/l |
| potassium hydrogen- | 1.0 | mmol/l |
| 2-ketoglutarate | | |
| Compound (I) | 10.0 | nmol/l |

(pH = 7.2)

The solution obtained in this way may for example be used for the preservation of donor hearts, for perfusion before or after the explantation of a donor heart, or for the reperfusion of a donor heart before, during or after implantation. In general, this solution is used under hypothermic conditions (4 to 8° C.).

1a. Cardioplegic Preservation and Perfusion Solution

This solution has the same composition as the solution described in 1., except that compound (I) was replaced by compound (II) (10 μmol/l). It may be used as described in 1.

### 2. Preservation and Perfusion Solution Based on a University of Wisconsin Solution (UW Solution)

In order to produce the solution, a commercially available UW solution was used. Compound (I) was added to this solution with a final concentration of 15 nmol/l.

The composition of the solution is as follows:

| | | |
|---|---|---|
| sodium chloride | 29.0 | mmol/l |
| potassium chloride | 125.0 | mmol/l |
| lactobionate | 100.0 | mmol/l |
| glutathione | 3.0 | mmol/l |
| adenosine | 5.0 | mmol/l |
| allopurinol | 1.0 | mmol/l |
| HES* | 50.0 | g/l |
| KH₂PO₄/KHPO₄⁻ | 25.0 | mmol/l |
| Compound (I) | 15.0 | nmol/l |

(pH = 7.4)
*hydroxyethyl starch

The solution obtained in this way may for example be used for the preservation of donor organs such as a liver, kidney or lung, for perfusion of these organs before or after explantation, or for reperfusion before, during or after implantation.

In general, this solution is used under hypothermic conditions (4 to 8° C.).

2a. Preservation and Perfusion Solution Based on a University of Wisconsin Solution (UW Solution)

This solution has the same composition as the solution described in 2., except that compound (I) was replaced by compound (II) (10 μmol/l). It is used as described in 2.

### 3. Preservation and Perfusion Solution Based on a Euro-Collins Solution

In order to produce the solution, a commercially available Euro-Collins solution was used. Compound (I) was added to this solution with a final concentration of 15 nmol/l.

The solution obtained in this way may for example be used for the preservation of donor organs such as a liver, kidney or lung, or vascular transplants, or for perfusion of these organs before or after explantation, or for reperfusion before, during or after implantation.

In general, this solution is used under hypothermic conditions (4 to 8° C.).

### 4. Preservative Effect

Vein segments (Vena-saphena-magna; length approx. 2-6 cm; from bypass patients) were stored at 8° C. for a period of 12 or 24 h in Euro-Collins solution (unmodified; control experiment) or in a Euro-Collins solution according to the invention, as described in 3. In a further series of experiments, a UW solution according to the invention as described in 2. was used, and a standard UW solution was used as a control solution.

The preservation state of the vascular endothelium was subsequently examined histologically. Particularly in the case of the samples stored for 24 h, the preservation of the tissue integrity of the vascular samples treated with the solution according to the invention was significantly better than for the controls.

The relaxation capability of the preserved vein sections was also examined. To this end annular sections (length approx. 3-5 mm) were separated from the vein segments and stretched on triangular stainless steel hooks, which were connected to an amplifying and measuring apparatus for registering the contraction and relaxation. The vascular rings were suspended in the respective preservation solution. In order to detect a dilatative reaction, the vascular rings were pre-contracted by means of phenylephrine and subsequently treated with acetylcholine or nitroglycerine. It was found that the contraction and relaxation properties were substantially preserved in the vascular segments treated with the solution according to the invention, even after four hours of storage, while a deterioration of the contraction and relaxation properties occurred with the vascular segments stored in the Euro-Collins solution. Significantly better preservation of the vitality of the preserved vascular sections was achieved by the solution according to the invention.

### 5. Perfusion/Storage of Rat Hearts

Isolated rat hearts (number: 36) were perfused by means of Langendorff perfusion apparatus and stored after 30 min in a preservation solution (4° C.). A Bretschneider's HTK solution (without active agents added; as a control), a modified HTK solution as specified above in 1., or a modified HTK solution as specified above in 1a. was used as the perfusion and preservation solution. In each case, 12 rat hearts were treated with one of said solutions. After a storage time of 6 hours, the hearts were reperfused with oxygenated Tyrode solution at 37° C. (1 h) and the coronary flow (ml/min) was determined. The best restoration of the coronary flow was observed in the hearts which had been treated with solution “1” or with solution “1a”.

6. Re-Implantation after Ischemia (Heart)

Male rabbits (New Zealand White Rabbits; 12 animals) were anesthetized, the heart was removed after thoracotomy, and the animals were connected to a heart-lung machine. The explanted parts were subsequently perfused by means of a perfusion machine with (A) a cardioplegic solution according to the invention (see above, 1.) or with (B) an unmodified HTK-Bretschneider solution (as a comparative experiment), each group (A, B) comprising six animals. The perfusion was carried out at 5° C. for a period of 90 min. The hearts were subsequently re-implanted. In all the experimental animals of Group A, the re-implanted heart resumed function and the status of the animals improved to full recovery. In group B, acute transplant failure (i.e. initial nonfunction) occurred in two animals, and three other animals of this group survived only a few days after re-implantation. As revealed by the autopsy result, this was attributable to dysfunction of the necrotically modified transplants.

The results show that the occurrence of reperfusion damage can effectively be prevented by using the perfusion solution according to the invention. Similar results were achieved when the above-described solution (1.a) was used instead of solution (1.).

7. Re-Implantation after Ischemia (Kidney)

For this series of experiments, dogs of the beagle breed were used (male, weight approx. 8-10 kg). The left kidney was removed from each dog under anesthesia, and was immediately perfused with a perfusion solution. The explanted kidneys were subsequently immersed at 4° C. respectively in the same perfusion solution, and stored at 4° C. for a period of three days.

A solution according to the invention based on UW solution (see above, 2.) was used as the perfusion solution. For control experiments, a conventional UW solution was used. Each group of experimental animals comprised four animals.

After three days, the kidneys were re-implanted in the dog from which they had been taken. At the same time, the contralateral (right) kidney was taken out.

After the end of the operation, the profile of the serum creatinine concentration was determined over a period of 10 days. In the group of experimental animals whose kidneys had been treated with the solution according to the invention, the serum creatinine concentration was on average less than half that measured for the control animals (unmodified UW solution). This showed that significantly better conservation and restoration of the kidney function was achieved by treating the kidneys with the solution according to the invention, than when using a conventional UW solution. This confirmed the effectiveness of the solutions according to the invention in organ and tissue preservation as well as in protection against ischemic damage and ischemia-reperfusion damage.

Comparable results were achieved when the above-described solution (2a) was used instead of solution (2.).

1. A solution for the perfusion and preservation of organs, organ parts, tissues or tissue parts of human or animal origin, comprising an NO-independent stimulator of soluble guanylate cyclase or an NO-independent activator of soluble guanylate cyclase.

2. The solution as claimed in claim 1, comprising an NO-independent activator of soluble guanylate cyclase selected from the group consisting of dicarboxylic amino acid derivatives and sulfur-substituted sulfonylamino carboxylic acid N-arylamides.

3. The solution as claimed in claim 1, comprising an NO-independent activator of soluble guanylate cyclase selected from the compounds of the following Formulae (I), (II), (III) and (IV):

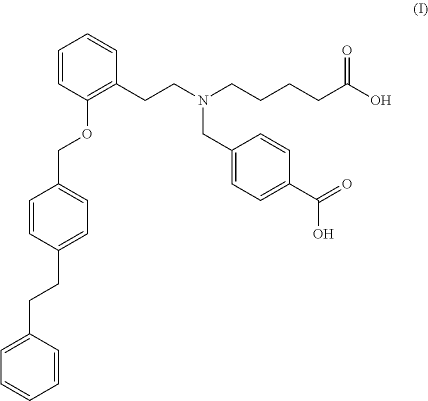

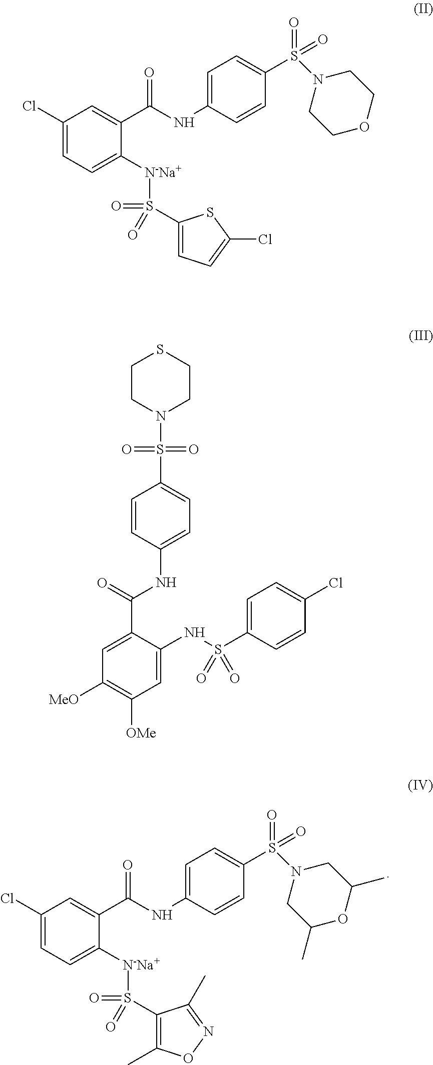

4. The solution as claimed in claim 1, comprising an NO-independent stimulator of soluble guanylate cyclase selected from the group consisting of substituted pyrazole derivatives, pyrazolopyridine derivatives, indazole derivatives, benzylindazole derivatives, and acrylamide derivatives.

5. The solution as claimed in claim 1, comprising an NO-independent stimulator of soluble guanylate cyclase selected from 3-(5′-hydroxymethyl-2′-furyl)-1-benzylindazole, 3-[2-(4-chlorophenylthio)phenyl]-N-(4-dimethylaminobutyl)acryl-amide, and the compounds of the following Formulae (V) to (VIII):

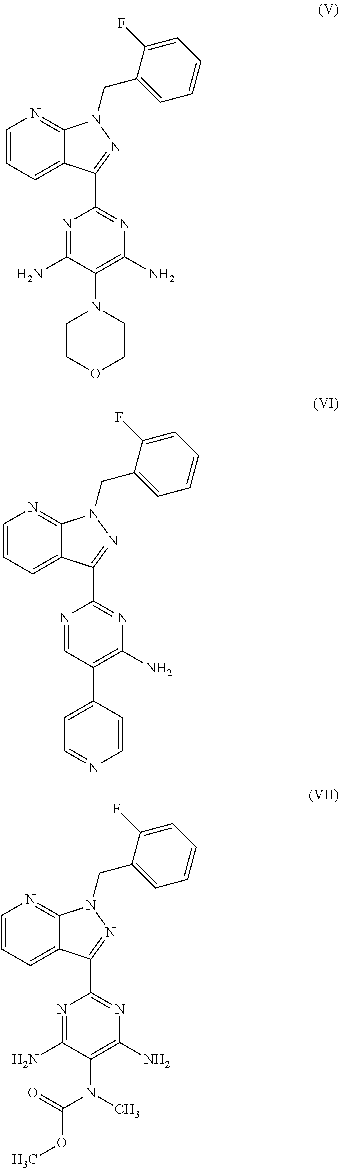

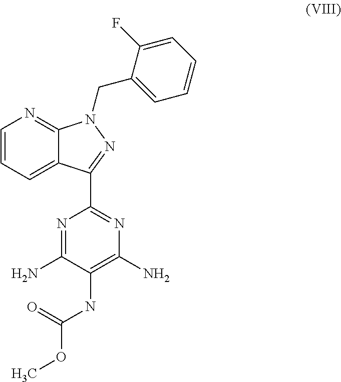

6. (canceled)

7. The solution as claimed in claim 1, wherein the solution is a physiological electrolyte solution comprising from 0.1 nmol/l to 100 μmol/l of NO-independent stimulators of soluble guanvlate cyclase and/or NO-independent activators of soluble guanvlate cyclase.

8. The solution as claimed in claim 1, comprising a base solution selected from the group consisting of UW solution University of Wisconsin solution), Bretschneider's HTK solution, Euro-Collins solution, blood plasma, and blood serum.

9. The solution as claimed in claim 1, wherein the solution is a cardioplegic solution.

10. The solution as claimed in claim 1, further comprising one or more pharmaceutically active agents selected from the group consisting of vasodilators, thrombocyte aggregation inhibitors, thrombolytics, coagulation inhibitors, phosphodiesterase inhibitors, adenosine agonists, prostaglandins, glucocorticoids, anti-inflammatory active agents and antibiotics.

11. A process for preparing a perfusion and preservation solution for organs, organ parts, tissue or tissue parts of human or animal origin, comprising adding an NO-independent stimulator of soluble guanylate cyclase or an NO-independent activator of soluble guanylate cyclase to a physiological electrolyte solution.

12-20. (canceled)

21. A method for treating isolated or explanted human or animal organs, organ parts, tissues or tissue parts comprising contacting the isolated or explanted organ, organ part, tissue or tissue part with a solution as claimed in claim 1.

22. The method as claimed in claim 21, wherein the isolated or explanted organ, organ part, tissue or tissue part is contacted with the solution by perfusion, immersion, rinsing, or injection.

23. A method for the transplantation of a human or animal organ, organ part, tissue or tissue part,
comprising contacting the organ, organ part, tissue or tissue part with a solution as claimed in claim 1 before, during or after implantation of the organ, organ part, tissue or tissue part in a recipient.

24. (canceled)

25. The method as claimed in claim 23, wherein the organ, organ part, tissue or tissue part is contacted with the solution by perfusion, immersion, rinsing, or injection.

26. The method as claimed in claim 23, wherein the organ, organ part, tissue or tissue part is contacted with the solution before removal from a donor.

27. A method for preserving or storing isolated or explanted organs, organ parts, tissues, tissue parts or cells of human or animal origin, comprising immersing the organ, organ part, tissue, tissue part or cells in a solution as claimed in claim 1.

28-30. (canceled)

31. The process of claim 11, wherein the prepared solution contains a total concentration of NO-independent stimulators of soluble guanylate cyclase and/or NO-independent activators of soluble guanylate cyclase in the range of from 0.1 nmol/l to 100 μmol/l.

32. The method of claim 21, wherein the organ, organ part, tissue, or tissue part is selected from the heart, lung, liver, kidney, pancreas, spleen, intestine, bladder, blood vessels, and lymph vessels.

33. The method of claim 23, wherein the organ, organ part, tissue, or tissue part is selected from the heart, lung, liver, kidney, pancreas, spleen, intestine, bladder, blood vessels, and lymph vessels.

34. The method of claim 27, wherein the organ, organ part, tissue, tissue part, or cells is selected from the heart, lung, liver, kidney, pancreas, spleen, intestine, bladder, blood vessels, lymph vessels, lymphocytes, and islet cells.
